(19) United States
(12) Patent Application Publication
(10) Pub. No.: US 2026/0118682 A1
(43) Pub. Date: Apr. 30, 2026

(54) CURVED COLLIMATOR WITH COLOR CORRECTION

(71) Applicant: GOOGLE LLC, Mountain View, CA (US)

(72) Inventors: Oscar Alberto Martinez, San Diego, CA (US); Ozan Cakmakci, San Bruno, CA (US)

(21) Appl. No.: 19/364,367

(22) Filed: Oct. 21, 2025

Related U.S. Application Data
(60) Provisional application No. 63/714,659, filed on Oct. 31, 2024.

(51) Int. Cl. G02B 27/01

(52) U.S. Cl. CPC G02B 27/0172; G02B 2027/0116; G02B 2027/0123; G02B 2027/013

(57) ABSTRACT

An apparatus includes a curved lightguide having a curved collimator configured to receive and collimate display light from a light source. A color correcting lens is disposed between the light source and an entrance surface of the curved collimator. The color correcting lens compensates for wavelength-dependent focal shifts by directing red, green, and blue portions of the display light to substantially overlap at a common focal plane of the curved collimator. Embedded freeform features configured as total internal reflection mirrors are provided within the curved collimator to collimate the display light. A pupil replicator is disposed within the curved lightguide and configured to expand an exit pupil based on the collimated display light.

### BACKGROUND

A collimator is an optical device that aligns light rays to travel parallel to the optical axis. This parallel alignment finds application in various optical fields, including imaging, laser systems, and telescopes, where precise light directionality is beneficial. In practical terms, a collimator shapes light from a source into a uniform, directed beam, minimizing divergence (the spread of light rays) and preserving the light’s quality and intensity over greater distances. Collimators enhance image clarity and focus by ensuring light travels in parallel paths, reducing distortions from scattered or angled light. For applications seeking enhanced optical performance, collimators are often designed with specific features, such as curved structures, to control light behavior within the system. In these designs, minimizing aberrations, particularly chromatic aberrations, contributes to producing high-quality images or beams.

### SUMMARY OF EMBODIMENTS

In accordance with one aspect, an apparatus includes a curved lightguide, a curved collimator disposed within the curved lightguide, a light source, and a color correcting lens disposed between the light source and an entrance surface of the curved collimator.

In at least some embodiments, the apparatus further includes a pupil replicator disposed within the curved lightguide.

In at least some embodiments, the pupil replicator is substantially flat.

In at least some embodiments, the curved lightguide is a freeform curved lightguide.

In at least some embodiments, the color correcting lens includes a material having one or both of a refractive index or dispersion different from that of the curved lightguide.

In at least some embodiments, the color correcting lens includes at least one diffractive optical element.

In at least some embodiments, the color correcting lens is one of bonded to or air-gapped with respect to the entrance surface of the curved collimator.

In at least some embodiments, the color correcting lens includes one of spherical or freeform surfaces.

In accordance with another aspect, a method of collimating display light includes projecting display light from a light source toward a curved collimator disposed within a curved lightguide. The display light is passed through a color correcting lens disposed between the light source and an entrance surface of the curved collimator. The color correcting lens reduces chromatic aberration of the display light. The display light within the curved collimator is collimated using embedded freeform features configured as total internal reflection (TIR) mirrors.

In at least some embodiments, the method further includes directing the collimated display light toward a pupil replicator disposed within the curved lightguide, the pupil replicator configured to expand an exit pupil.

In at least some embodiments, the method further includes compensating for wavelength-dependent focal shifts by directing red, green, and blue portions of the display light through the color correcting lens so that the portions overlap at a common focal plane of the curved collimator. An exit pupil is expanded with a pupil replicator using the collimated display light.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a diagram illustrating an example of axial color aberration.

FIG. 2 is a diagram illustrating an example of lateral color aberration.

FIG. 3 shows an example curved lightguide including a curved collimator having color correction in accordance with some embodiments.

FIG. 4 shows an example head-mounted display (HMD) system employing the curved lightguide including the curved collimator with color correction of FIG. 1 in accordance with some embodiments.

FIG. 5 is a flow diagram illustrating an example method of collimating display light using the curved collimator of FIG. 1 in accordance with some embodiments.

### DETAILED DESCRIPTION

In optical systems, achieving a larger exit pupil is desirable to cover a large population of users, especially when paired with a flat pupil expander. A curved collimator architecture is one approach to achieving this objective, using a single-substrate collimator with a curved structure to improve light collimation and system compactness. However, while promising in many respects, this design encounters disadvantages when attempting to expand the exit pupil due to optical aberrations, particularly chromatic aberrations.

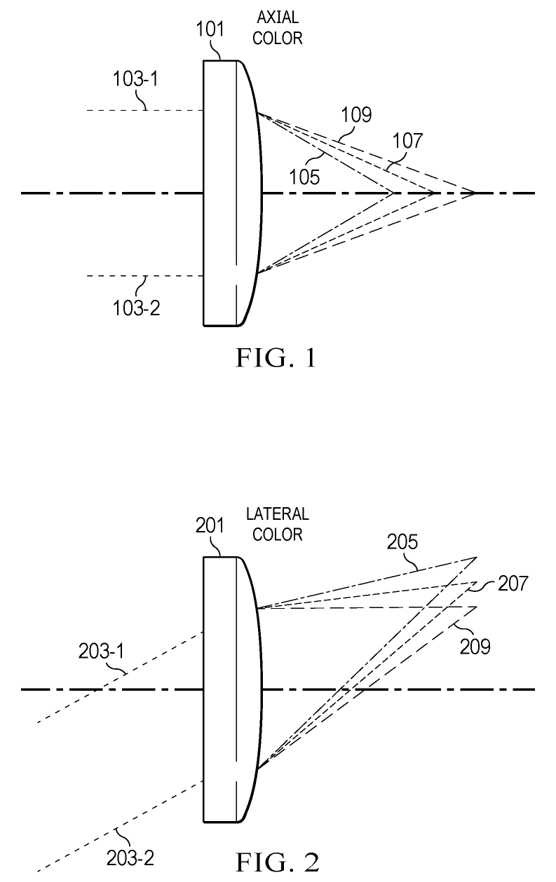

Chromatic aberration poses a considerable challenge in optical design, as this type of aberration prevents effective light collimation across different wavelengths, leading to reduced image clarity and color accuracy. Chromatic aberrations are generally categorized into two primary types, axial color and lateral color. As illustrated in FIG. 1, axial color aberration occurs when the focal length of an optical element 101 changes with wavelength, causing different colors to focus at different distances along the optical axis. In this example, incoming display light 103 (illustrated as display light 103-1 and display light 103-2) passes through the optical element 101. The optical element 101 separates the incoming display light 103 into a red ray 105, a green ray 107, and a blue ray 109, each represented by a different dashed line. Each wavelength converges at a different focal position, making it difficult to maintain uniform image focus across the visible spectrum. Stated differently, the separation of focal planes means that not all wavelengths are simultaneously in focus, resulting in image blur and loss of sharpness across the visible spectrum. This color aberration is particularly problematic in applications that rely on consistent image quality and color fidelity.

As illustrated in FIG. 2, lateral color aberration arises from a wavelength-dependent change in magnification through an optical element 201. Incoming display light 203 (illustrated as display light 203-1 and display light 203-2) enters the optical element 201 and is refracted into a red ray 205, a green ray 207, and a blue ray 209. Because these output rays diverge at different lateral positions, the image exhibits color fringing or rainbow-like distortions around edges. This lateral color aberration becomes increasingly pronounced at higher field angles and can significantly impair image uniformity and resolution, particularly in optical systems striving for larger exit pupils.

Current single-substrate curved collimator design struggles with mitigating these chromatic aberrations, especially as the exit pupil size increases. The limitation lies primarily in the inability of a single-material substrate to sufficiently correct these aberrations without compromising optical performance. Consequently, there is a need for an improved collimator design that can maintain optical efficiency, minimize aberrations, and support larger exit pupils in high-performance optical systems.

As such, the following describes embodiments of a curved collimator implementing color correction to address and overcome the issues described above by, for example, enabling color correction to increase the exit pupil size while minimally impacting the overall form factor. In at least some embodiments, a curved lightguide includes a curved collimator that receives display light from a microdisplay. A color correcting lens is disposed between the microdisplay and an entrance surface of the curved collimator to compensate for wavelength-dependent variations in focal length and magnification. The color correcting lens may be formed of a material having a refractive index and dispersion characteristics different from those of the curved lightguide or collimator substrate, thereby reducing axial and lateral color aberrations that would otherwise limit exit pupil expansion.

In at least some embodiments, the color correcting lens incorporates one or more diffractive optical elements (DOE) to further manage chromatic dispersion by directing red, green, and blue wavelengths along controlled paths. Such diffractive structures may be implemented as microstructured grooves or patterns on a surface of the lens, allowing precise control over color correction without significantly increasing thickness or weight. The color correcting lens may include spherical surfaces, freeform surfaces, or a combination thereof, depending on design requirements for compactness and correction performance.

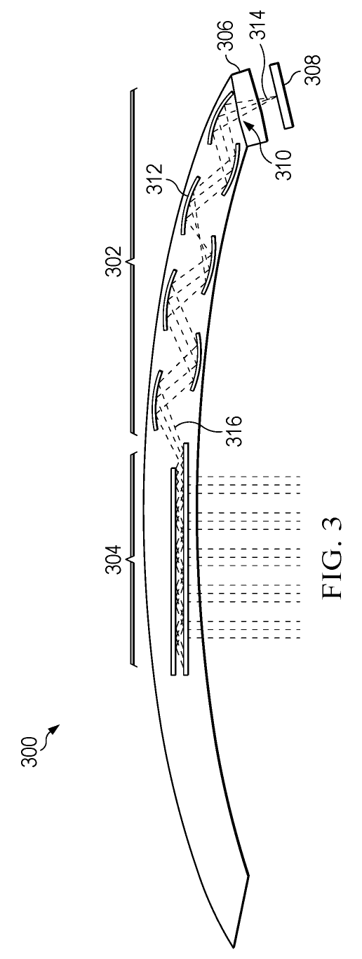

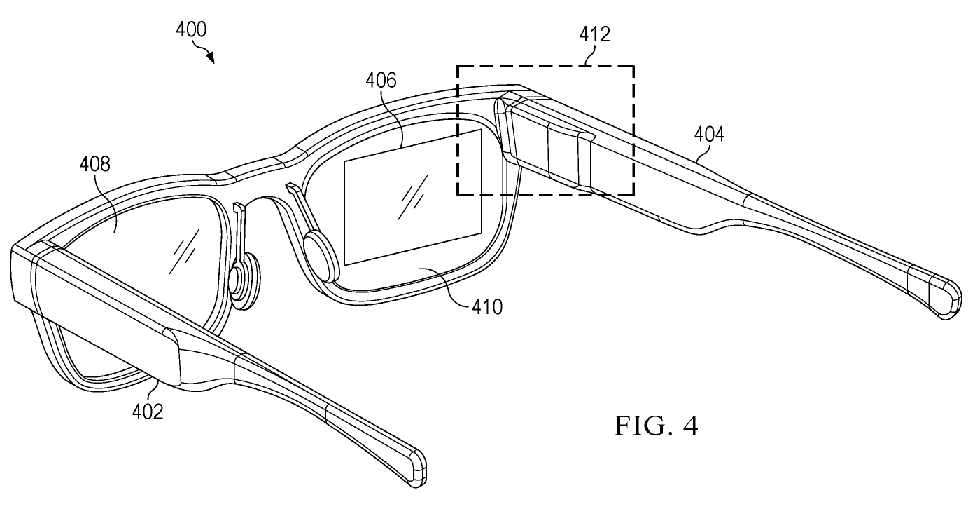

FIG. 3 illustrates an example of a color-corrected curved lightguide 300 (also referred to herein as “lightguide 300”). The lightguide 300 includes a curved collimator 302 configured to receive and collimate image light into substantially parallel rays. The curved geometry of the collimator 302 allows for compact packaging and efficient light guidance while also enabling expansion of the exit pupil when paired with a pupil replicator 304. The pupil replicator 304 is configured to distribute the collimated light across multiple laterally displaced positions to generate an enlarged eyebox for a user. In at least some embodiments, the pupil replicator 304 is substantially flat, while in other embodiments the replicator facets may be curved or otherwise powered to impart additional optical control, such as prescription correction or virtual image distance adjustment.

A light source, such as a microdisplay 308 (e.g., a micro-light emitting diode (microLED) display, a micro-organic light emitting diode (microOLED) display, or a liquid crystal on silicon (LCoS) display), is positioned to project display light 314 into the lightguide 300. MicroLED displays can provide high brightness and long operational lifetimes, making them suitable for outdoor or high-illumination environments. MicroOLED displays can offer high resolution and contrast ratios, which are beneficial for fine image detail in compact form factors. LCoS displays utilize a reflective liquid crystal layer on a silicon backplane, enabling high pixel density and precise control of phase or amplitude modulation, making them effective for both monochrome and full-color image projection. Other display engines, such as scanning laser projectors, may also be used to generate the display light 314. Between the microdisplay 308 and an entrance surface 310 of the curved collimator 302 is a color correcting lens 306. The color correcting lens 306, in at least some embodiments, is bonded directly to the entrance surface 310 or mounted with an intentional air gap, depending on alignment tolerances, assembly requirements, and the desired balance of optical performance and manufacturability.

The color correcting lens 306 provides compensation for chromatic aberration before the display light 314 enters the curved collimator 302. In at least some embodiments, the lens 306 is fabricated from a material having a refractive index and dispersion different from that of the lightguide 300 or collimator 302, thereby counteracting the wavelength-dependent refraction introduced by the collimator substrate. In other embodiments, the lens 306 includes one or more diffractive optical elements (DOE) patterned into or applied onto a surface of the lens. Such DOEs may be realized using microstructured grooves, holographic gratings, or blazed reliefs configured to direct different wavelengths along controlled optical paths. In still other embodiments, the lens 306 combines refractive and diffractive features to achieve broadband correction in a compact geometry. The lens surfaces, in at least some embodiments, are spherical, which simplifies manufacture and alignment, or freeform, which allows asymmetric optical correction tailored to off-axis fields and compact device packaging.

During operation, light rays emitted by the microdisplay 308 first pass through the color correcting lens 306. As the rays traverse the lens, chromatic focal shifts and magnification errors are reduced, such that red, green, and blue wavelengths are more closely aligned. This ensures that the rays enter the curved collimator 302 through the entrance surface 310 in a corrected state. The entrance surface 310, in at least some embodiments, is planar or shaped, depending on the desired coupling efficiency and angular distribution.

Once inside the curved collimator 302, the rays are guided along the lightguide 300, where embedded freeform features 312, configured as total internal reflection (TIR) mirrors, progressively redirect and collimate the light 314. Each freeform feature 312 is shaped to control both the direction and angular distribution of the incident rays such that light entering at different field angles is redirected toward a common propagation direction. The geometry of the freeform features 312, in at least some embodiments, is non-uniform along the length of the collimator 302 to account for varying incident ray paths, thereby ensuring uniform collimation across the full field of view.

In at least some embodiments, the freeform features 312 are recessed or protruding facets formed within the substrate of the lightguide 300. These features rely on total internal reflection, where light striking the interface at greater than the critical angle is reflected without loss. By configuring the facet orientations and curvatures, the freeform features 312 can simultaneously collimate the light 314 and distribute intensity evenly across the aperture of the lightguide 300. In other embodiments, the freeform features 312 are implemented as partially reflective coatings applied to localized regions of the collimator 302 to achieve similar directional control. The progressive action of multiple freeform features 312 along the propagation path allows the system to collimate light 314 from the microdisplay 308 in a compact geometry while minimizing aberrations. Because each feature 312 contributes incrementally to the overall collimation, the configuration avoids sharp transitions that would otherwise introduce scattering or diffraction artifacts. This distributed collimation approach improves optical efficiency, uniformity of brightness, and clarity of the final image projected to the user.

The collimated light 316 emerging from the collimator 302 is directed toward the pupil replicator 304, which increases the effective exit pupil size by replicating the optical pupil across multiple lateral positions. In at least some embodiments, the pupil replicator 304 is substantially flat and functions as an exit pupil expander. In other embodiments, the replicator facets are curved or powered to impart additional optical functions. For example, powered facets may be used to adjust the focal distance of the virtual image or to embed prescription correction directly into the optical architecture. In such cases, the configuration of the color correcting lens 306 can be tuned to cooperate with the pupil replicator 304 so that chromatic aberration is minimized across the enlarged eyebox. The combined effect of the corrected collimator 302 and pupil replicator 304 enables delivery of a wide exit pupil with high image clarity, uniformity, and color fidelity in a compact optical assembly suitable for head-worn displays.

The color correcting lens 306, in at least some embodiments, is manufactured and integrated with the curved collimator 302 using a variety of techniques. The lens 306, in at least some embodiments, is bonded to the entrance surface 310 of the collimator 302 using an optical adhesive selected to minimize interface reflections and index mismatch. Adhesive bonding can be achieved by, for example, ultraviolet (UV) curing of a thin adhesive layer or by thermal curing processes. In other embodiments, the lens 306 is directly fusion bonded to the collimator 302 by applying controlled heat and pressure at the interface, creating a seamless optical joint without an intermediate adhesive layer. When an air gap is implemented between the lens 306 and the entrance surface 310, precision spacers or alignment fixtures, in at least some embodiments, are used during assembly to maintain a defined separation distance and angular orientation. Such air-gapped embodiments help accommodate thermal expansion mismatches between dissimilar materials, reducing the likelihood of stress or misalignment.

For embodiments incorporating diffractive optical elements, the DOE may be formed on one or more surfaces of the lens 306 by one or more microfabrication techniques. These include, for example, photolithographic patterning of microstructures into a photoresist layer followed by etching into a glass or polymer substrate, embossing or injection molding of diffractive patterns into a polymer surface, or direct laser writing of surface relief features. In hybrid refractive-diffractive designs, the DOE can be applied as a thin patterned layer atop a refractive lens substrate, enabling compact broadband correction with minimal additional bulk.

The pupil replicator 304 and the embedded freeform features of the curved collimator 302, in at least some embodiments, are likewise formed using precision molding, diamond turning, or etching processes, depending on material selection. For glass lightguides, freeform TIR surfaces can be machined by, for example, precision grinding and polishing, or etched using reactive ion etching or laser ablation techniques. For polymer lightguides, injection molding, hot embossing, or other techniques may be used to replicate freeform geometries at scale. These manufacturing approaches provide multiple pathways for realizing the optical system of FIG. 1, ensuring that the color-corrected curved lightguide 300 can be implemented using materials and processes suitable for mass production of head-worn display components. By allowing flexibility in bonding, air-gapping, DOE fabrication, and freeform feature replication, the system can be adapted for different cost, performance, and form-factor requirements while still achieving the chromatic correction benefits described herein.

FIG. 4 illustrates an example apparatus, such as a head-wearable display (HWD) system 400, for implementing the lightguide 300 including the curved collimator 302 with color correction described above with respect to FIG. 3. In the illustrated implementation, the HWD system 400 utilizes an eyeglasses form factor. However, the HWD system 400 is not limited to this form factor and, thus, may have a different shape and appearance from the eyeglasses frame depicted in FIG. 4, such as headsets or goggles. The HWD system 400 includes a support structure 402 (e.g., a support frame) to mount to a head of a user, and that includes an arm 404 that houses an image source, such as a light projection system, including a microdisplay (e.g., microlight emitting diode (LED) display) or other light engine, configured to project display light representative of images or imagery toward the eye of a user, such that the user perceives the projected display light as a sequence of images displayed in a field of view (FOV) area 406 at one or both of lens elements 408, 410 supported by the support structure 402. In at least some embodiments, the support structure 402 further includes various sensors, such as one or more front-facing cameras, rear-facing cameras, other light sensors, motion sensors, accelerometers, and the like. The support structure 402, in at least some embodiments, further includes one or more radio frequency (RF) interfaces or other wireless interfaces, such as a Bluetooth (TM) interface, a Wi-Fi interface, and the like.

The support structure 402, in at least some embodiments, further includes one or more batteries or other portable power sources for supplying power to the electrical components of the HWD system 400. In at least some embodiments, some or all of these components of the HWD system 400 are fully or partially contained within an inner volume of support structure 402, such as within the arm 404 in region 412 of the support structure 402. In the illustrated implementation, the HWD system 400 utilizes an eyeglasses form factor. However, the HWD system 400 is not limited to this form factor and, thus, may have a different shape and appearance from the eyeglasses frame depicted in FIG. 3.

One or both of the lens elements 408, 410 are used by the HWD system 400 to provide an immersive display in which rendered graphical content can be superimposed over or otherwise provided in conjunction with a real-world view as perceived by the user through the lens elements 408, 410. For example, microOLED light, micro LED light, laser light, or other display light is used to form a perceptible image or series of images projected onto the user’s eye via one or more optical elements, including a waveguide, formed at least partially in the corresponding lens element. One or both of the lens elements 408, 410 thus include at least a portion of a waveguide that routes display light received by an incoupler (not shown in FIG. 4) of the waveguide to an outcoupler (not shown in FIG. 4) of the waveguide, which outputs the display light toward an eye of a user of the HWD system 400. Additionally, the waveguide employs an exit-pupil-expander (not shown in FIG. 4) in the light path between the incoupler and outcoupler or in combination with the outcoupler to increase the dimensions of the display exit pupil. Each lens element 408, 410 is sufficiently transparent to allow a user to see through the lens elements to provide a field of view of the user’s real-world environment such that the image appears superimposed over at least a portion of the real-world environment.

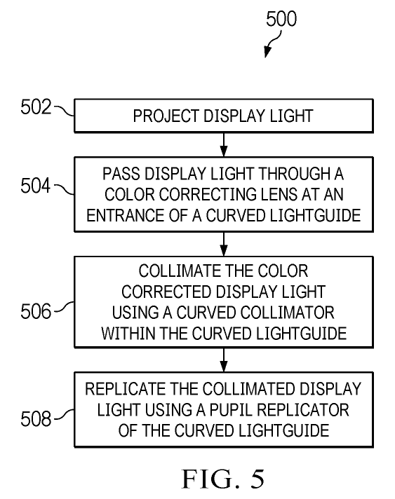

FIG. 5 illustrates a flow diagram of a method 500 of collimating display light, in accordance with at least some embodiments. The processes described with respect to the method 500 are detailed further above with reference to FIG. 3 and FIG. 4. For illustrative purposes, the method 500 is described with respect to the curved lightguide 300 and its associated components described above with respect to FIG. 3. However, it will be appreciated that the described method can be implemented within systems having different configurations or adapted to various optical environments. Additionally, the illustrated operations are not strictly limited to the specific sequence depicted in FIG. 5, as operations may occur concurrently, in parallel, or in alternative orders. The described method 500 may also incorporate additional operations beyond those depicted in FIG. 5.

At block 502, the method 500 includes projecting display light 314 from a light source, toward a curved collimator 302 disposed within a curved lightguide. The light source, in at least some embodiments, is a microdisplay 308, such as a microLED, microOLED, or liquid crystal on silicon (LCoS) panel. The microdisplay 308 generates image light 314 that is injected into the curved lightguide so that the light 314 is directed toward the curved collimator 302 for further optical processing.

At block 504, the display light is passed through a color correcting lens 306 disposed between the light source and an entrance surface of the curved collimator 302, the color correcting lens reducing chromatic aberration of the display light. The color correcting lens 306 may be fabricated from a material having refractive index and dispersion properties different from the lightguide substrate, or may include diffractive optical structures. By adjusting the paths of red, green, and blue wavelengths before they enter the curved collimator 302, the color correcting lens 306 compensates for wavelength-dependent focal shifts by directing red, green, and blue portions of the display light so that the portions overlap at a common focal plane of the curved collimator. This operation ensures that each wavelength is aligned to the same focal point at the entrance of the curved collimator, thereby preventing axial and lateral color errors that would otherwise degrade image fidelity.

At block 506, the display light 314 is collimated within the curved collimator 302 using embedded freeform features 312 configured as, for example, TIR mirrors. These freeform features 312 may be recessed or protruding facets within the substrate, or may be formed with reflective coatings. Each feature 312 incrementally redirects and aligns the light 314 rays, ensuring that the output from the curved collimator 302 is substantially parallel and uniform across the field of view.

At block 508, the collimated display light 316 is directed toward a pupil replicator 304 disposed within the curved lightguide 300. In at least some embodiments, the pupil replicator 304 is configured to expand an exit pupil. The pupil replicator 304 replicates the optical pupil across multiple positions, thereby enlarging the eyebox so that the display can be comfortably viewed even if the user’s eye moves relative to the optical axis. In some implementations, the pupil replicator 304 is flat, while in other implementations, the replicator 304 may include facets configured to impart optical power for functions such as prescription correction or virtual image distance adjustment. Following pupil replication, the display light 314 exits the curved lightguide 300 toward the eye of a user.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is, therefore, evident that the particular embodiments disclosed above may be altered or modified, and all such variations are considered within the scope of the disclosed subject matter. Accordingly, the protection sought herein is as set forth in the claims below.

What is claimed is:

1. An apparatus, comprising:
a curved lightguide;
a curved collimator disposed within the curved lightguide;
a light source; and
a color correcting lens disposed between the light source and an entrance surface of the curved collimator.

2. The apparatus of claim 1, further comprising:
a pupil replicator disposed within the curved lightguide.

3. The apparatus of claim 2, wherein the pupil replicator is substantially flat.

4. The apparatus of claim 1, wherein the curved lightguide is a freeform curved lightguide.

5. The apparatus of claim 1, wherein the color correcting lens comprises a material having one or both of a refractive index or dispersion different from that of the curved lightguide.

6. The apparatus of claim 1, wherein the color correcting lens comprises at least one diffractive optical element.

7. The apparatus of claim 1, wherein the color correcting lens is one of bonded to or air-gapped with respect to the entrance surface of the curved collimator.

8. The apparatus of claim 1, wherein the color correcting lens comprises one of spherical or freeform surfaces.

9. A method of collimating display light, comprising:
projecting display light from a light source toward a curved collimator disposed within a curved lightguide;
passing the display light through a color correcting lens disposed between the light source and an entrance surface of the curved collimator, the color correcting lens reducing chromatic aberration of the display light; and
collimating the display light within the curved collimator using embedded freeform features configured as total internal reflection (TIR) mirrors.

10. The method of claim 9, further comprising:
directing the collimated display light toward a pupil replicator disposed within the curved lightguide, the pupil replicator configured to expand an exit pupil.

11. The method of claim 9, further comprising:
compensating for wavelength-dependent focal shifts by directing red, green, and blue portions of the display light through the color correcting lens so that the portions overlap at a common focal plane of the curved collimator; and
expanding an exit pupil with a pupil replicator using the collimated display light.
